(19) United States
(12) Patent Application Publication
(10) Pub. No.: US 2023/0370176 A1
(43) Pub. Date: Nov. 16, 2023

(54) ANTENNA BLOCKING ALARM METHOD, AND COMMUNICATION CHIP AND DEVICE

(71) Applicant: HUAWEI TECHNOLOGIES CO., LTD., Shenzhen, Guangdong (CN)

(72) Inventors: Kai ZHOU, Shanghai (CN); Qinghui WANG, Shanghai (CN); Yanjie GU, Shenzhen (CN)

(73) Assignee: HUAWEI TECHNOLOGIES CO., LTD., Shenzhen, Guangdong, GD (CN)

(21) Appl. No.: 18/360,272

(22) Filed: Jul. 27, 2023

Related U.S. Application Data
(63) Continuation of application No. PCT/CN2021/074255, filed on Jan. 28, 2021.

(51) Int. Cl. H04B 17/19; H04B 17/318; H04B 17/23

(52) U.S. Cl. CPC H04B 17/19; H04B 17/318; H04B 17/23

(57) ABSTRACT

Embodiments of this application disclose a blocked antenna alarm method, and a communication chip and device that relate to the chip field. The embodiments resolve a problem where a communication device cannot prompt a user that an antenna of the communication device is blocked. In the method, the communication chip obtains an attenuation value of an air interface loopback signal through an antenna of the communication device. The communication chip then determines, based on the attenuation value, whether the antenna is blocked. When it is determined that the antenna is blocked, the communication chip indicates a processor of the communication device to output, to a user, alarm information indicating that the antenna is blocked.

### CROSS-REFERENCE TO RELATED APPLICATIONS

This application is a continuation of International Application No. PCT/CN2021/074255, filed on Jan. 28, 2021, the disclosure of which is hereby incorporated by reference in its entirety.

### TECHNICAL FIELD

This application generally relates to the chip field, and in particular, to an antenna blocking alarm method (e.g., a blocked antenna alarm), and a communication chip and device.

### BACKGROUND

Conventionally, when using mobile phones, due to some user's preferences and habits, the users may protect their mobile phones by using protective cases; these cases comes in a variety of different materials. As a result, an antenna of the mobile phone may blocked by the protective case, which results in the phone's signal to be weak or for the phone not to receive any signal. In some scenarios, with or without the protective case, the user may have the mobile phone in a landscape view by hold the phone with both of their hands. As a result, the antenna of the mobile phone may be blocked by the hands of the user, which results in the phone's signal to be weak or for the phone not to receive any signal.

Signal strength of the mobile phone is an important performance factor for a mobile phone that may directly impact user experience. For example, when the signal of the mobile phone is typically weak or when a signal is commonly not received, the user may not be able to determine a reason as to what is causing the signal quality deterioration. Therefore, a solution is urgently needed to resolve the aforementioned problems.

### SUMMARY

Embodiments of this application provide for an antenna blocking alarm method (e.g., a blocked antenna alarm), and a communication chip and device, to resolve a problem that a communication device does prompt (e.g., indicate to) a user, when the user uses the communication device and an antenna of the communication device is blocked.

To achieve the foregoing objective, the following technical solutions are used in embodiments of this application.

According to a first aspect, an embodiment of this application provides an antenna blocking alarm method (e.g., a blocked antenna alarm). The method may be applied to a communication chip of a communication device. The method may include that the communication chip obtains an attenuation value of an air interface loopback signal through an antenna. Also in the method, the communication chip determines, based on the attenuation value, whether the antenna is blocked. When determining that the antenna is blocked, the communication chip indicates a processor to output, to a user, alarm information prompting (e.g., indicating) that the antenna is blocked.

By using the foregoing technical solution, whether the antenna of the communication device is blocked may be determined based on the attenuation value of the signal. When it is determined that the antenna is blocked, the alarm information is output to prompt the user that the antenna is blocked. In this way, the user can find, based on the alarm information, that the antenna of the communication device is blocked, and then remove an obstacle (such as a protective case or a user's hands) in a timely manner, thereby improving user experience.

In a possible implementation, the antenna may include a first antenna and a second antenna. That the communication chip obtains the attenuation value of the air interface loopback signal through the antenna includes that the communication chip transmits a measurement signal through the first antenna, and receives the measurement signal looped back to the second antenna. The communication chip determines the attenuation value based on a strength value of the measurement signal and a strength value of the looped back measured signal. In this way, the communication chip measures, through an air interface loopback measurement, the attenuation value when the measurement signal is received. This facilitates a measurement and can avoid interference caused by an external environment (for example, such as a building) to measure the attenuation value.

In another possible implementation, the communication chip includes a Bluetooth module and a wireless fidelity (Wi-Fi) network module. That the communication chip transmits the measurement signal through the first antenna, and receives the measurement signal looped back to the second antenna includes that the Bluetooth module transmits the measurement signal through the first antenna. The Wi-Fi network module receives the measurement signal looped back to the second antenna. The Wi-Fi network module determines the attenuation value based on the strength value of the measurement signal and the strength value of the looped back measurement signal.

In another possible implementation, that the communication chip obtains the attenuation value of the air interface loopback signal through the antenna includes that the communication chip periodically obtains a plurality of attenuation values based on a preset periodicity. That the communication chip determines, based on the attenuation value, whether the antenna is blocked includes that the communication chip determines, based on the plurality of obtained attenuation values, whether the antenna is blocked. In this way, whether the antenna is blocked can be more accurately determined based on the plurality of obtained attenuation values, and this reduces misjudgment.

In another possible implementation, that the communication chip determines, based on the attenuation value, whether the antenna is blocked includes that the communication chip determines whether a difference between the attenuation value within first preset duration and an attenuation calibration value is greater than a first preset threshold. When the difference between the attenuation value within the first preset duration and the attenuation calibration value is greater than the first preset threshold, the communication chip determines that the antenna is blocked. When the difference between the attenuation value within the first preset duration and the attenuation calibration value is not greater than the first preset threshold, the communication chip determines that the antenna is not blocked.

In another possible implementation, that the communication chip determines, based on the attenuation value, whether the antenna is blocked includes that when a difference between the attenuation value obtained before second preset duration and an attenuation calibration value is less than a second preset threshold, the communication chip determines whether differences between a plurality of attenuation values consecutively obtained within the second preset duration and the attenuation calibration value are all greater than the second preset threshold. When the differences between the plurality of attenuation values consecutively obtained within the second preset duration and the attenuation calibration value are all greater than the second preset threshold, the communication chip determines that the antenna is blocked. When the differences between the plurality of attenuation values consecutively obtained within the second preset duration and the attenuation calibration value are not all greater than the second preset threshold, the communication chip determines that the antenna is not blocked.

In another possible implementation, that the communication chip determines that the antenna is blocked includes that the communication chip determines, based on status indication information, that the antenna is blocked due to a holding position by the user of the communication device, where the status indication information indicates that the communication device is in a landscape mode.

According to a second aspect, an embodiment of this application provides a communication chip. The communication chip may be used in a communication device. The communication chip may implement functions performed by the communication chip in the first aspect or the possible designs of the first aspect, and the functions may be implemented by hardware. The hardware includes one or more modules corresponding to the foregoing functions. For example, the communication chip may include a control module, a transceiver module, and the like. The transceiver module may further include a baseband module, a radio frequency module, and the like.

The control module may be configured to obtain an attenuation value of an air interface loopback signal through an antenna. The control module may be further configured to determine, based on the attenuation value, whether the antenna is blocked. When determining that the antenna is blocked, the control module may be further configured to indicate a processor to output, to a user, alarm information prompting that the antenna is blocked.

In a possible implementation, the antenna includes a first antenna and a second antenna, and the communication chip further includes the transceiver module. The transceiver module is configured to transmit, based on control of the control module, a measurement signal through the first antenna, receive the measurement signal looped back to the second antenna, and measure a strength value of the looped back measurement signal. The control module is configured to determine the attenuation value based on a strength value of the measurement signal and the strength value of the looped back measurement signal.

In another possible implementation, the transceiver module includes the baseband module and the radio frequency module. The baseband module is configured to generate the measurement signal based on the control of the control module. The radio frequency module is configured to transmit the measurement signal through the first antenna, and receive the measurement signal looped back to the second antenna. The baseband module is further configured to measure the strength value of the looped back measurement signal.

In another possible implementation, the control module includes a first control module and a second control module. The baseband module includes a Bluetooth baseband module and a Wi-Fi baseband module, and the radio frequency module includes a Bluetooth radio frequency module and a Wi-Fi radio frequency module. The Bluetooth baseband module is configured to generate the measurement signal based on control of the first control module. The Bluetooth radio frequency module is configured to transmit the measurement signal through the first antenna. The Wi-Fi radio frequency module is configured to receive the measurement signal looped back to the second antenna. The Wi-Fi baseband module is configured to measure the strength value of the looped back measurement signal. The second control module is configured to determine the attenuation value based on the strength value of the measurement signal and the strength value of the looped back measurement signal.

In another possible implementation, the control module is configured to periodically obtain a plurality of attenuation values based on a preset periodicity, and determine, based on the plurality of obtained attenuation values, whether the antenna is blocked.

In another possible implementation, the control module is configured to determine whether a difference between the attenuation value within first preset duration and an attenuation calibration value is greater than a first preset threshold. When the difference between the attenuation value within the first preset duration and the attenuation calibration value is greater than the first preset threshold, the control module is configured to determine that the antenna is blocked. When the difference between the attenuation value within the first preset duration and the attenuation calibration value is not greater than the first preset threshold, the control module is configured to determine that the antenna is not blocked.

In another possible implementation, the control module is configured to, when a difference between the attenuation value obtained before second preset duration and an attenuation calibration value is less than a second preset threshold, determine whether differences between a plurality of attenuation values consecutively obtained within the second preset duration and the attenuation calibration value are all greater than the second preset threshold. When the differences between the plurality of attenuation values consecutively obtained within the second preset duration and the attenuation calibration value are all greater than the second preset threshold, the control module is configured to determine that the antenna is blocked. When the differences between the plurality of attenuation values consecutively obtained within the second preset duration and the attenuation calibration value are not all greater than the second preset threshold, the control module is configured to determine that the antenna is not blocked.

In another possible implementation, the control module is configured to determine, based on status indication information, that the antenna is blocked due to a holding position by the user of the communication device, where the status indication information indicates that the communication device is in a landscape mode.

According to a third aspect, an embodiment of this application provides a communication chip. The communication chip is used in a communication device, configured to perform the antenna blocking alarm method according to any one of the first aspect or the possible designs of the first aspect.

According to a fourth aspect, an embodiment of this application provides a chipset. The chipset may be used in a communication device. The chipset may include a processor and the communication chip according to the third aspect. The communication chip may be configured to perform the antenna blocking alarm method according to any one of the first aspect or the possible designs of the first aspect. The processor may be configured to control, based on an indication of the communication chip, the communication device to output, to a user, alarm information prompting that the antenna is blocked.

According to a fifth aspect, an embodiment of this application provides a communication device. The communication device may include an antenna and the chipset according to the fourth aspect. When the communication device runs, the chipset may perform the antenna blocking alarm method according to any one of the first aspect or the possible designs of the first aspect.

It should be understood that, for beneficial effects of the second aspect to the fifth aspect, refer to related descriptions in the first aspect. Details are not described herein again.

According to a sixth aspect, an embodiment of this application provides another antenna blocking alarm method. The method may be applied to a communication device having an antenna. The method may include that the communication device obtains an attenuation value of an air interface loopback signal through an antenna. The communication device determines, based on the attenuation value, whether the antenna is blocked. When determining that the antenna is blocked, the communication device outputs, to a user, alarm information prompting that the antenna is blocked.

By using the foregoing technical solution, whether the antenna of the communication device is blocked may be determined based on the attenuation value of the signal. When it is determined that the antenna is blocked, the alarm information is output to prompt the user that the antenna is blocked. In this way, the user can find, based on the alarm information, that the antenna of the communication device is blocked, and then remove an obstacle (such as a protective case on the communication device or the user's hands on the communication device) in a timely manner, to improve user experience.

In a possible implementation, the antenna may include a first antenna and a second antenna. That the communication device obtains the attenuation value of the air interface loopback signal through the antenna includes that the communication device transmits a measurement signal through the first antenna, and receives the measurement signal looped back to the second antenna. The communication device determines the attenuation value based on a strength value of the measurement signal and a strength value of the looped back measured signal. In this way, a communication chip measures, through air interface loopback measurement, the attenuation value when the measurement signal is received. This facilitates measurement and can avoid interference caused by an external environment, such as a building, to measure the attenuation value.

In another possible implementation, that the communication device obtains the attenuation value of the air interface loopback signal through the antenna includes that the communication device periodically obtains a plurality of attenuation values based on a preset periodicity. That the communication device determines, based on the attenuation value, whether the antenna is blocked includes that the communication device determines, based on the plurality of obtained attenuation values, whether the antenna is blocked. In this way, whether the antenna is blocked can be more accurately determined based on the plurality of obtained attenuation values, and this reduces misjudgment.

In another possible implementation, that the communication device determines, based on the attenuation value, whether the antenna is blocked includes that the communication device determines whether a difference between the attenuation value within first preset duration and an attenuation calibration value is greater than a first preset threshold. When the difference between the attenuation value within the first preset duration and the attenuation calibration value is greater than the first preset threshold, the communication device determines that the antenna is blocked. When the difference between the attenuation value within the first preset duration and the attenuation calibration value is not greater than the first preset threshold, the communication device determines that the antenna is not blocked.

In another possible implementation, that the communication device determines, based on the attenuation value, whether the antenna is blocked includes that when a difference between the attenuation value obtained before second preset duration and an attenuation calibration value is less than a second preset threshold, the communication device determines whether differences between a plurality of attenuation values consecutively obtained within the second preset duration and the attenuation calibration value are all greater than the second preset threshold. When the differences between the plurality of attenuation values consecutively obtained within the second preset duration and the attenuation calibration value are all greater than the second preset threshold, the communication device determines that the antenna is blocked. When the differences between the plurality of attenuation values consecutively obtained within the second preset duration and the attenuation calibration value are not all greater than the second preset threshold, the communication device determines that the antenna is not blocked.

In another possible implementation, that the communication device determines that the antenna is blocked includes that the communication device determines, based on status indication information, that the antenna is blocked due to a holding position by the user of the communication device, where the status indication information indicates that the communication device is in a landscape mode.

In another possible implementation, that the communication device outputs, to a user, alarm information prompting that the antenna is blocked may include that the communication device displays a user interface, where the user interface includes an icon indicating that the antenna is blocked, and/or a pop-up message indicating that the antenna is blocked. The user is prompted (e.g., informed), by using the icon or the pop-up message, that the antenna of the communication device is blocked. This implementation provides a simple approach to notifying the user, which results in the user to correct what is causing the weak signal

In another possible implementation, the method further includes that the communication device displays a first icon, where the first icon indicates strength of the signal received by the communication device. That the communication device outputs, to a user, alarm information prompting that the antenna is blocked includes that the communication device updates and displays the first icon as a second icon, where the second icon indicates that the antenna is blocked.

According to a seventh aspect, an embodiment of this application provides a communication device, including a processor and a memory that is configured to store executable instructions of the processor. When the processor is configured to execute the instructions, the communication device is enabled to implement the antenna blocking alarm method according to any one of the sixth aspect or the possible implementations of the sixth aspect.

According to an eighth aspect, an embodiment of this application provides a computer-readable storage medium. The computer-readable storage medium stores computer program instructions. When the computer program instructions are executed by a communication device, the communication device is enabled to implement the antenna blocking alarm method according to any one of the sixth aspect or the possible implementations of the sixth aspect.

According to a ninth aspect, an embodiment of this application provides a computer program product, including computer-readable code. When the computer-readable code runs in a communication device, the communication device is enabled to implement the antenna blocking alarm method according to any one of the sixth aspect or the possible implementations of the sixth aspect.

It should be understood that, for beneficial effects of the seventh aspect to the ninth aspect, refer to related description in the sixth aspect. Details are not described herein again.

### BRIEF DESCRIPTION OF DRAWINGS

FIG. 1 is a signal strength indication icon according to a related technology;

FIG. 2 is another signal strength indication icon according to a related technology;

FIG. 3 is a schematic diagram of a structure of a communication device according to an embodiment of this application;

FIG. 4 is a schematic flowchart of an antenna blocking alarm method according to an embodiment of this application;

FIG. 5 is a schematic composition diagram of a wireless communication subsystem according to an embodiment of this application;

FIG. 6 is a schematic composition diagram of another wireless communication subsystem according to an embodiment of this application;

FIG. 7 is a schematic diagram of an interface when an antenna blocking alarm method is applied according to an embodiment of this application;

FIG. 8 is a schematic diagram of another interface when an antenna blocking alarm method is applied according to an embodiment of this application;

FIG. 9 is a schematic diagram of another interface when an antenna blocking alarm method is applied according to an embodiment of this application;

FIG. 10 is a schematic diagram of a structure of a communication chip according to an embodiment of this application;

FIG. 11 is a schematic diagram of a structure of another communication chip according to an embodiment of this application; and

FIG. 12 is a schematic diagram of a structure of another communication chip according to an embodiment of this application.

### DESCRIPTION OF EMBODIMENTS

When using a wireless communication device (for example, a mobile phone), antenna performance is an important indicator that is reflective of a communication capability of the wireless communication device, and is also an important performance factor that impacts a user's experience. Generally, an antenna of the wireless communication device is designed and evaluated based on an antenna directivity and a multi-antenna performance consistency so that the antenna may ensure that the wireless communication device has sufficient antenna performance when used by a user. However, when using the wireless communication device, due to some user's preferences and habits, the antenna of the wireless communication device may be blocked, thereby affecting the antenna performance. For example, the antenna may be partially or completely blocked when, in order to provide protection to the device or for aesthetic purposes, the user may select a case that may be composes of a variety of materials. Alternatively, the device may be mounted and/or placed in a particular position (e.g., a car mount). Alternatively, the user may hold the device with their hands in a particular manner. When the antenna performance of the wireless communication device is temporarily deteriorated because the antenna is blocked, the user may not be aware as to what reason is causing the signal deterioration.

Therefore, a mobile phone is used as an example. In a related technology, the mobile phone may indicate, by using a signal energy indication (e.g., received signal strength indication, RSSI), energy (or strength) of a signal received by the mobile phone, to indicate, to a user, the strength of the signal received by the mobile phone.

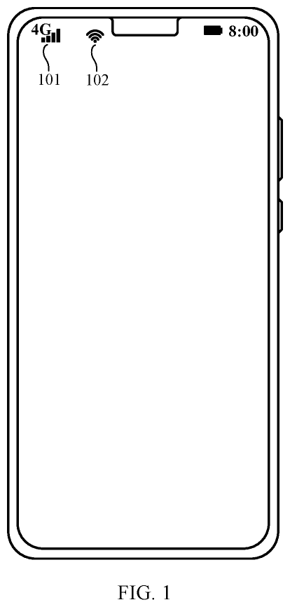

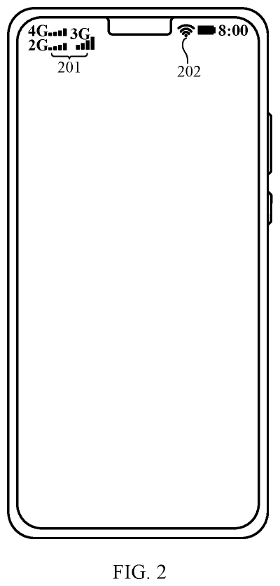

For example, after the mobile phone is connected to a fourth generation (e.g., 4th generation, 4G) mobile communication network, the mobile phone may periodically perform an RSSI measurement on a received 4G signal. As shown in FIG. 1, a 4G signal strength indication icon 101 is displayed in a status bar of the mobile phone. The strength indication icon 101 can display a signal level in real time. For example, a larger quantity of displayed bars indicates a better received signal (or a higher signal strength), and a smaller quantity of displayed bars indicates a weaker received signal (or a lower signal strength). For another example, the mobile phone may alternatively simultaneously perform RSSI measurement on received signals of second generation (e.g., 2nd generation, 2G), third generation (e.g., 3rd generation, 3G), and 4G mobile communication networks. As shown in FIG. 2, a strength indication icon 201 that can simultaneously indicate the signals of the 2G, 3G, and 4G mobile communication networks is displayed in the status bar of the mobile phone.

Alternatively, after the mobile phone is connected to a wireless fidelity (Wi-Fi) network, the mobile phone may perform an RSSI measurement on a received Wi-Fi signal. As shown in FIG. 1, a Wi-Fi signal strength indication icon 102 is displayed in the status bar. Alternatively, as shown in FIG. 2, a Wi-Fi signal strength indication icon 202 is displayed in the status bar. The strength indication icon can display a signal level in real time. For example, a larger quantity of displayed bars indicates a better received signal (or a higher signal strength), and a smaller quantity of displayed bars indicates a weaker received signal (or a lower signal strength).

However, the RSSI measurement can only indicate the strength of the signal received by the mobile phone. Therefore, the strength indication icon displayed based on the RSSI measurement can indicate the energy of the signal currently received by the mobile phone. For example, when a quantity of bars displayed in the strength indication icon decreases, it implies that the energy of the signal received by the mobile phone decreases. The energy of the signal received by the mobile phone may decrease because a transmit power of a peer device (for example, a base station) decreases, signal attenuation between the mobile phone and the peer device increases (for example, a distance between the mobile phone and the peer device increases, or there is a building or wall between the mobile phone and the peer device), or because of an antenna performance exception of the mobile phone. Therefore, it is difficult for the user to determine, from the strength indication icon displayed on the mobile phone, whether the antenna performance of the mobile phone has deteriorated because the antenna is blocked. As a result, the user may not remove an obstacle to the antenna of the mobile phone, which results in a negative user experience.

To resolve the foregoing problem, an embodiment of this application provides an antenna blocking alarm method (e.g., a blocked antenna alarm). The method may be applied to a communication device having an antenna. The method may include that the communication device obtains an attenuation value of an air interface loopback signal through an antenna, and determines, based on the attenuation value, whether the antenna of the communication device is blocked. After determining that the antenna of the communication device is blocked, the communication device may output, to a user, alarm information prompting that the antenna is blocked.

According to the method, the communication device may determine, based on the attenuation value of the signal, whether the antenna of the communication device is blocked. When it is determined that the antenna is blocked, the alarm information is output to prompt the user that the antenna is blocked. In this way, the user can find, based on the alarm information, that the antenna of the communication device is blocked, and then remove an obstacle (such as a case or the user's hands) in a timely manner, thereby improving the user's experience using the mobile device.

The following description describes the antenna blocking alarm method (e.g., a blocked antenna alarm) provided in some embodiments with reference to the accompanying drawings by using examples.

It should be noted that the antenna blocking alarm method provided in some embodiments may be applied to various communication devices, and the communication device may include a communication chip. For example, the communication device may be a mobile phone, a tablet computer, a wearable device having a wireless communication capability, a television, a notebook computer, a desktop computer, or an augmented reality (AR)/virtual reality (VR) device. For another example, the communication chip may be a wireless communication chip such as a Wi-Fi chip, a Bluetooth chip, or a global navigation satellite system (GNSS) chip, or a mobile communication chip such as a 2G, a 3G, a 4G, or a fifth generation (e.g., 5th generation, 5G) chip. Alternatively, the communication chip may be an integrated chip that integrates two or more of the foregoing chip functions. For example, the communication chip may be an integrated chip that integrates a Wi-Fi module, a Bluetooth module, and a GNSS module, to provide Wi-Fi, Bluetooth, and GNSS functions. For another example, the communication chip may be a modem chip that integrates a 2G module, a 3G module, a 4G module, and a 5G module.

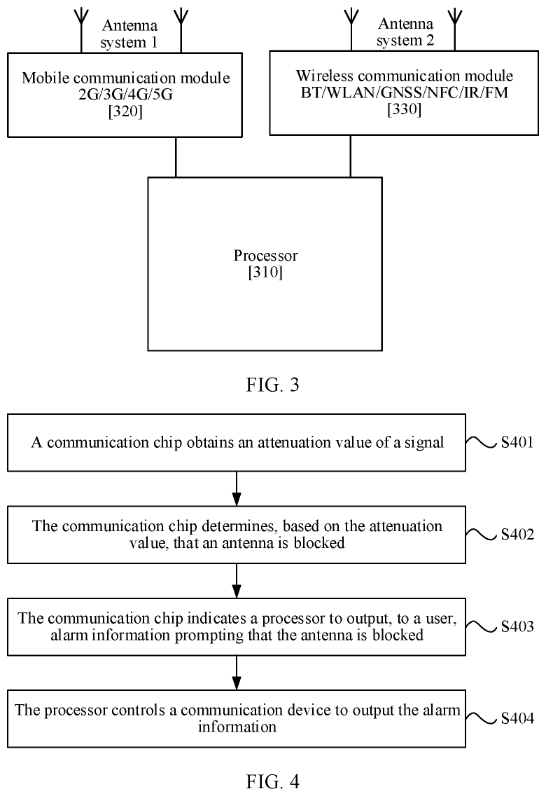

An example in which the communication device is a mobile phone is used to describe a structure of the communication device. FIG. 3 is a schematic diagram of a structure of a communication device according to an embodiment of this application.

As shown in FIG. 3, the communication device may include a processor 310, an antenna system 1, an antenna system 2, a mobile communication module 320, a wireless communication module 330, and the like. The processor 310 may include one or more processing units. For example, the processor 310 may include an application processor (AP), a modem processor, a graphics processing unit (GPU), an image signal processor (ISP), a controller, a memory, a video codec, a digital signal processor (DSP), a baseband processor, and/or a neural-network processing unit (NPU). Different processing units may be independent components, or may be integrated into one or more processors.

The controller may be a nerve center and a command center of the communication device. The controller may generate an operation control signal based on instruction operation code and a time sequence signal, to complete control of instruction fetching and instruction execution.

The memory may be further disposed in the processor 310, and is configured to store instructions and data. In some embodiments, the memory in the processor 310 is a cache. The memory may store instructions or data just used or cyclically used by the processor 310. When the processor 310 needs to use the instructions or the data again, the processor may directly invoke the instructions or the data from the memory. This avoids repeated access, reduces waiting time of the processor 310, and improves system efficiency.

A wireless communication function of the communication device may be implemented by using the antenna system 1, the antenna system 2, the mobile communication module 320 (or referred to as the mobile communication chip), the wireless communication module 330 (or referred to as the wireless communication chip), or the like.

The antenna system 1 and the antenna system 2 are configured to transmit and receive an electromagnetic wave signal. Each antenna in the communication device may be configured to cover one or more communication frequency bands. Different antennas may be further multiplexed, to improve antenna utilization. For example, the antenna system 1 may be multiplexed as a diversity antenna of a wireless local area network. In some other embodiments, the antenna may be used in combination with a tuning switch.

The mobile communication module 320 may provide a solution that is applied to the communication device and that is for wireless communication including 2G, 3G, 4G, 5G, and the like. The mobile communication module 320 may include at least one filter, a switch, a power amplifier, a low noise amplifier (LNA), and the like. The mobile communication module 320 may receive an electromagnetic wave through the antenna system 1, perform processing such as filtering or amplification on the received electromagnetic wave, and transmit the electromagnetic wave to the modem processor for demodulation. The mobile communication module 320 may further amplify a signal modulated by the modem processor, and convert the signal into an electromagnetic wave for radiation through the antenna system 1. In some embodiments, at least some functional modules in the mobile communication module 320 may be disposed in the processor 310. In some embodiments, at least some functional modules in the mobile communication module 320 may be disposed in a same component as at least some modules in the processor 310.

The wireless communication module 330 may provide a solution that is applied to the communication device and that is for wireless communication including a wireless local area network (WLAN) (for example, a Wi-Fi network), Bluetooth, a global navigation satellite system, and the like. The wireless communication module 330 may be one or more components integrating at least one communication processing module. The wireless communication module 330 receives an electromagnetic wave through the antenna system 2, performs frequency modulation and filtering processing on an electromagnetic wave signal, and sends a processed signal to the processor 310. The wireless communication module 330 may further receive a to-be-sent signal from the processor 310, perform frequency modulation and amplification on the signal, and convert the signal into an electromagnetic wave for radiation through the antenna system 2.

In some embodiments, in the communication device, the antenna system 1 and the mobile communication module 320 are coupled, and the antenna system 2 and the wireless communication module 330 are coupled, so that the communication device can communicate with a network and another device by using a wireless communication technology. The wireless communication technology may include a global system for mobile communications (GSM), a general packet radio service (GPRS), code division multiple access (CDMA), wideband code division multiple access (WCDMA), time-division code division multiple access (TD-CDMA), long term evolution (LTE), Bluetooth, a GNSS, a WLAN technology, and the like. The GNSS may include a global positioning system (GPS), a global navigation satellite system (GLONASS), a BeiDou navigation satellite system (BDS), a quasi-zenith satellite system (QZSS), and/or a satellite based augmentation system (SBAS).

It may be understood that the structure shown in this embodiment does not constitute a limitation on the communication device. In some other embodiments of this application, the communication device may include more or fewer components than those shown in the figure, or some components may be combined, or some components may be split, or there may be a different component layout. The components shown in the figure may be implemented by hardware, software, or a combination of software and hardware. For example, the communication device may further include an external memory interface, an internal memory, a universal serial bus (USB) interface, a charging management module, a power management module, a battery, an audio module, a speaker, a receiver, a microphone, a headset jack, a sensor module, a button, a motor, an indicator, a camera, a display screen, a subscriber identification module (SIM) card interface, and the like. The sensor module may include a pressure sensor, a gyro sensor, an acceleration sensor, a touch sensor, and the like.

That the communication device is a mobile phone is still used as an example. The wireless communication module 330 shown in FIG. 3 may be used as the communication chip to form a chipset with the processor 310, and the mobile communication module 320 may also be used as the communication chip to form a chipset with the processor 310.

All methods in the following embodiments may be implemented by using the foregoing chipset.

That the communication device is a mobile phone is still used as an example. FIG. 4 is a schematic flowchart of an antenna blocking alarm method according to an embodiment of this application. As shown in FIG. 4, the method may include the following S401 to S404.

S401: A communication chip obtains an attenuation value of a signal.

The attenuation value may indicate attenuation of a strength value when the signal is received in comparison to a strength value when the signal is sent.

In some embodiments, the communication chip may perform air interface loopback measurement through an antenna to obtain the attenuation value of the signal. In other words, the communication chip obtains an attenuation value of an air interface loopback signal through the antenna. For example, when antennas of the communication device include a first antenna and a second antenna (for example, the first antenna and the second antenna are two antennas in the antenna system 1 shown in FIG. 3, or two antennas in the antenna system 2) that are individually connected to the communication chip, the communication chip may control the first antenna to transmit a measurement signal, and receive the measurement signal through the second antenna. Then, the communication chip determines the attenuation value based on a difference between a strength value of the measurement signal received through the second antenna and a strength value of the measurement signal transmitted through the first antenna. A coverage frequency of the first antenna and a coverage frequency of the second antenna need to have an overlapping frequency band, to avoid that the air interface loopback measurement cannot be completed because the measurement signal transmitted through the first antenna is not within the coverage frequency of the second antenna and therefore cannot be received.

It should be noted that a plurality of first antennas and/or second antennas may be separately disposed. In other words, in the air interface loopback measurement performed by the communication chip, a plurality of air interface loopbacks may be formed by using a plurality of antennas. For example, the communication chip may separately transmit a measurement signal through the plurality of first antennas, so that one second antenna separately receives the measurement signal transmitted through the plurality of first antennas, to form the plurality of air interface loopbacks. For example, the plurality of first antennas are a first antenna 1 and a first antenna 2, and one second antenna is a second antenna 1. The communication chip separately transmits a measurement signal through the first antenna 1 and the first antenna 2, and separately receives, through the second antenna 1, the measurement signal transmitted through the first antenna 1 and the measurement signal transmitted through the first antenna 2, to form two air interface loopbacks. Alternatively, the communication chip may separately transmit a measurement signal through the plurality of first antennas, so that the plurality of second antennas receive the corresponding measurement signal, to form a plurality of air interface loopbacks. For example, the plurality of first antennas are a first antenna 1 and a first antenna 2, and the plurality of second antennas are a second antenna 1 and a second antenna 2. The communication chip separately transmits a measurement signal through the first antenna 1 and the first antenna 2, receives, through the second antenna 1, the measurement signal transmitted through the first antenna 1, and receives, through the second antenna 2, the measurement signal transmitted through the first antenna 2, to form two air interface loopbacks. Alternatively, the communication chip may transmit a measurement signal through one first antenna, and the plurality of second antennas separately receive the measurement signal, to form a plurality of air interface loopbacks. For example, one first antenna is a first antenna 1, and the plurality of second antennas are a second antenna 1 and a second antenna 2. The communication chip transmits a measurement signal through the first antenna 1, and receives, through the second antenna 1 and the second antenna 2, the measurement signal transmitted through the first antenna 1, to form two air interface loopbacks.

In some embodiments, when the communication chip performs air interface loopback measurement by forming a plurality of air interface loopbacks, the communication chip may calculate first attenuation values corresponding to different air interface loopbacks, and then determine a final attenuation value based on the first attenuation values, to improve accuracy of the determined attenuation value. For example, the communication chip may use an average value of the plurality of obtained first attenuation values as the finally determined attenuation value. For example, when the communication chip separately transmits the measurement signal through the first antenna 1 and the first antenna 2, receives, through the second antenna 1, the measurement signal transmitted through the first antenna 1, and receives, through the second antenna 2, the measurement signal transmitted through the first antenna 2, to form the two air interface loopbacks, the communication chip determines an attenuation value 1 based on a difference between a strength value of the measurement signal transmitted through the first antenna 1 and a strength value of the measurement signal received through the second antenna 1 and transmitted through the first antenna 1. The communication chip then determines an attenuation value 2 based on a difference between a strength value of the measurement signal transmitted through the first antenna 2 and a strength value of the measurement signal received through the second antenna 1 and transmitted through the first antenna 2. Then, the communication chip determines a final attenuation value based on an average value of the attenuation value 1 and the attenuation value 2.

In some other embodiments, when the communication chip performs air interface loopback measurement by forming a plurality of air interface loopbacks, the communication chip may alternatively calculate and determine an attenuation value based on an average value of strength values of a measurement signal transmitted through the first antennas, and an average value of strength values of the measurement signal received through the second antennas. For example, when the communication chip separately transmits the measurement signal through the first antenna 1 and the first antenna 2, receives, through the second antenna 1, the measurement signal transmitted through the first antenna 1, and receives, through the second antenna 2, the measurement signal transmitted through the first antenna 2, to form the two air interface loopbacks, the communication chip calculates an average value (for example, referred to as a first average value) of a strength value of the measurement signal transmitted through the first antenna 1 and a strength value of the measurement signal transmitted through the first antenna 2. The communication chip then calculates an average value (for example, referred to as a second average value) of a strength value of the measurement signal received through the second antenna 1 and a strength value of the measurement signal received through the second antenna 2. Then, the communication chip calculates and obtains an attenuation value based on a difference between the first average value and the second average value.

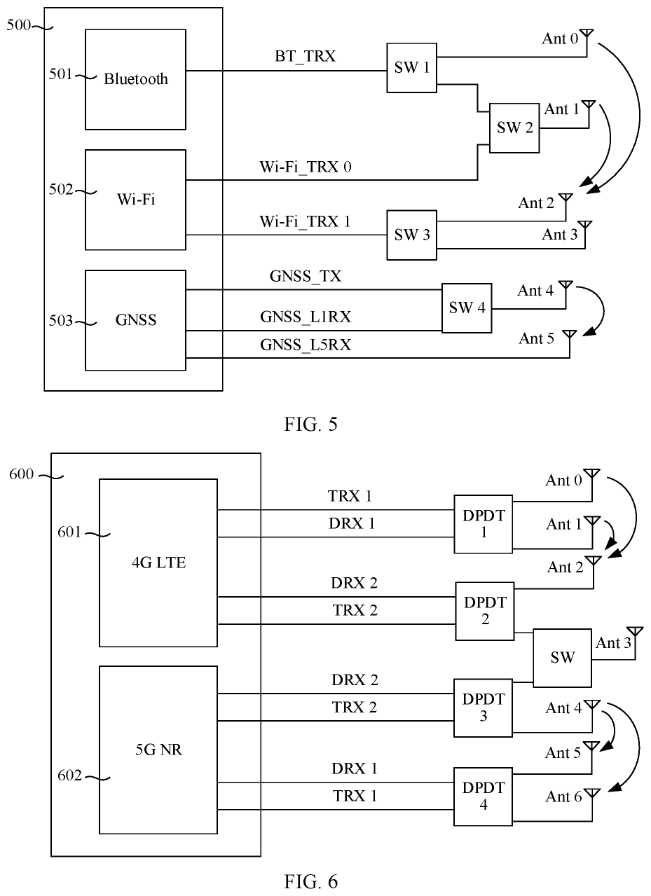

For example, FIG. 5 is a schematic composition diagram of a wireless communication subsystem according to an embodiment of this application. As shown in FIG. 5, the wireless communication subsystem includes a communication chip 500, a switch (SW), and an antenna (e.g., Ant). The communication chip 500 is a Wi-Fi/Bluetooth/GNSS chip. To be specific, the communication chip 500 integrates a Bluetooth module 501, a Wi-Fi module 502, and a GNSS module 503. A transmit/receive channel (BT TRX) of the Bluetooth module 501 is connected to an Ant 0 through an SW 1, and the SW 1 is connected to an Ant 1 through an SW 2. A transmit/receive channel (Wi-Fi_TRX) 0 of the Wi-Fi module 502 is connected to the Ant 1 through the SW 2, and a Wi-Fi_TRX 1 of the Wi-Fi module 502 is connected to an Ant 2 and an Ant 3 through an SW 3. A transmit channel (GNSS_TX) and a first receive channel (GNSS_L1RX) of the GNSS module 503 are connected to an Ant 4 through an SW 4, and a second receive channel (GNSS_L5RX) is connected to an Ant 5. It should be noted that the communication chip 500 may transmit and receive a signal through a correspondingly connected antenna over a transmit and receive channel, may transmit a signal through a correspondingly connected antenna over a transmit channel, and may receive a signal through a correspondingly connected antenna over a receive channel.

The communication chip 500 shown in FIG. 5 is used as an example. When a Wi-Fi service of the communication chip 500 is idle, the Bluetooth module 501 of the communication chip generates a monophonic signal or a modulation signal of specific strength, for example, a first strength value, as a measurement signal. The Bluetooth module 501 of the communication chip 500 controls the SW 1 to transmit the measurement signal through the Ant 0 (where for example, the Ant 0 may be a first antenna in some embodiments). The Wi-Fi module 502 of the communication chip 500 controls the SW 3 to receive the measurement signal through the Ant 2 (where for example, the Ant 2 may be a second antenna in some embodiments). Then, the Wi-Fi module 502 of the communication chip 500 measures a strength value of the received measurement signal, for example, obtains a second strength value. The Wi-Fi module 502 of the communication chip 500 may obtain the first strength value from the Bluetooth module 501, and obtain an attenuation value of the measurement signal through calculation based on the first strength value and the second strength value. For example, a difference between the second strength value and the first strength value may be determined as the attenuation value of the measurement signal. In this way, air interface loopback measurement is completed.

Optionally, the Bluetooth module 501 of the communication chip 500 may further generate a monophonic signal or a modulation signal of specific strength, for example, a first strength value, as a measurement signal. The Bluetooth module 501 of the communication chip 500 controls the SW 1 and the SW 2 to separately transmit the measurement signal through the Ant 0 and the Ant 1 (where for example, the Ant 0 and the Ant 1 may be first antennas in some embodiments). The Wi-Fi module 502 of the communication chip 500 controls the SW 3 to receive, through the Ant 2, the measurement signal separately transmitted through the Ant 0 and the Ant 1, to form two air interface loopbacks. Then, the Wi-Fi module 502 of the communication chip 500 measures a strength value of the received measurement signal transmitted through the Ant 0, for example, obtains a second strength value, and measures a strength value of the received measurement signal transmitted through the Ant 1, for example, obtains a third strength value. The Wi-Fi module 502 of the communication chip 500 may obtain the first strength value from the Bluetooth module 501, determine a difference between the first strength value and the second strength value as a first attenuation value, and determine a difference between the first strength value and the third strength value as a second attenuation value. Finally, a final attenuation value is determined based on an average value of the first attenuation value and the second attenuation value, and air interface loopback measurement is completed.

For another example, the GNSS module 503 of the communication chip 500 generates a monophonic signal or a modulation signal of specific strength, for example, a first strength value, as a measurement signal. The GNSS module 503 of the communication chip 500 controls the SW 4 to transmit the measurement signal through the Ant 4 (where for example, the Ant 4 may be a first antenna in some embodiments). The GNSS module 503 of the communication chip 500 receives the measurement signal through the Ant 5 (where for example, the Ant 5 may be a second antenna in some embodiments). Then, the GNSS module 503 of the communication chip 500 measures a strength value of the received measurement signal, for example, obtains a second strength value. The GNSS module 503 of the communication chip 500 may determine a difference between the first strength value and the second strength value as an attenuation value of the measurement signal, to complete air interface loopback measurement.

It should be noted that the communication chip may alternatively be a Wi-Fi chip, a Bluetooth chip, a GNSS chip, or the like that is independently disposed. For an implementation of air interface loopback measurement, refer to an air interface loopback measurement process of the communication chip shown in FIG. 5. Details are not described herein again.

For example, FIG. 6 is a schematic composition diagram of another wireless communication subsystem according to an embodiment of this application. As shown in FIG. 6, the wireless communication subsystem includes a communication chip 600, and the communication chip 600 is a 4G long term evolution (LTE)/5G new radio (NR) modem chip that integrates a 4G LTE module 601 and a 5G NR module 602. A transmit channel (TRX) 1 and a receive channel (DRX) 1 of the 4G LTE module 601 are connected to an antenna (Ant) 0 and an Ant 1 through a double pole double throw switch (DPDT) 1. A TRX 2 and a DRX 2 of the 4G LTE module 601 are connected to an Ant 2 and a switch (SW) through a DPDT 2, and the SW is connected to an Ant 3. A TRX 2 and a DRX 2 of the 5G NR module 602 are connected to an Ant 4 and the switch (SW) through a DPDT 3. A TRX 1 and a DRX 1 of the 5G NR module 602 are connected to an Ant 5 and an Ant 6 through a DPDT 4. It should be noted that the communication chip 600 may transmit a signal through a correspondingly connected antenna over a transmit channel, and receive the signal through a correspondingly connected antenna over a receive channel.

The communication chip 600 shown in FIG. 6 is used as an example. The 4G LTE module 601 of the communication chip 600 may generate a monophonic signal or a modulation signal of specific strength, for example, a first strength value, as a measurement signal. The 4G LTE module 601 of the communication chip 600 controls the DPDT 1 to separately transmit the measurement signal through the Ant 0 (where for example, the Ant 0 may be a first antenna in some embodiments) and the Ant 1 (where for example, the Ant 1 may be a first antenna in some embodiments). The 4G LTE module 601 of the communication chip 600 may control the DPDT 2 to receive, through the Ant 2 (where for example, the Ant 2 may be a second antenna in some embodiments), the measurement signal separately transmitted through the Ant 0 and the Ant 1, to form two air interface loopbacks. Then, the 4G LTE module 601 of the communication chip 600 measures a strength value of the received measurement signal transmitted through the Ant 0, for example, obtains a second strength value, and measures a strength value of the received measurement signal transmitted through the Ant 1, for example, obtains a third strength value. The 4G LTE module 601 of the communication chip 600 may determine a difference between the first strength value and the second strength value as a first attenuation value, and determine a difference between the first strength value and the third strength value as a second attenuation value. Finally, a final attenuation value is determined based on an average value of the first attenuation value and the second attenuation value, and air interface loopback measurement is completed.

For another example, the 5G NR module 602 of the communication chip 600 may generate a monophonic signal or a modulation signal of specific strength, for example, a first strength value, as a measurement signal. The 5G NR module 602 of the communication chip 600 controls the DPDT 3 to transmit the measurement signal through the Ant 4. The 5G NR module 602 of the communication chip 600 controls the DPDT 4 to separately receive the measurement signal through the Ant 5 and the Ant 6, to form two air interface loopbacks. Then, the 5G NR module 602 of the communication chip 600 measures a strength value of the measurement signal received through the Ant 5, for example, obtains a second strength value, and measures a strength value of the measurement signal received through the Ant 6, for example, obtains a third strength value. The 5G NR module 602 of the communication chip 600 may determine a difference between the first strength value and the second strength value as a first attenuation value, and determine a difference between the first strength value and the third strength value as a second attenuation value. Finally, a final attenuation value is determined based on an average value of the first attenuation value and the second attenuation value, and air interface loopback measurement is completed.

The communication chip may alternatively be a 4G LTE chip, a 5G NR chip, or the like that is independently disposed. For an implementation of air interface loopback measurement, refer to an air interface loopback measurement process of the communication chip shown in FIG. 6. Details are not described herein again.

It should be noted that the first strength value, the second strength value, and the third strength value may be RSSI values respectively corresponding to the measurement signal. Correspondingly, the communication chip may obtain an RSSI value by performing RSSI detection on the received measurement signal. This is not limited herein.

S402: The communication chip determines, based on the attenuation value, that the antenna is blocked.

In some possible implementations, the communication chip may periodically obtain attenuation values of a signal. Then, within preset duration, the communication chip compares a plurality of obtained attenuation values with an attenuation calibration value, to determine that the antenna is blocked. For example, within the preset duration (for example, within first preset duration), when a difference between an attenuation value and the attenuation calibration value is continuously greater than a preset threshold (for example, a first preset threshold), it may be determined that the antenna is blocked. For example, within a specific duration (for example, 8 hours), when a difference between an attenuation value obtained each time and the attenuation calibration value is greater than the preset threshold (for example, 5 dB), it may be determined that the antenna is blocked.

Optionally, that the communication chip determines, based on the attenuation value, that the antenna is blocked may alternatively include that within a preset duration, when a quantity of times that a difference between the attenuation value and the attenuation calibration value is greater than the preset threshold is greater than a preset quantity of times, it may be determined that the antenna is blocked. For example, within a specific duration (for example, 8 hours), when the differences between the obtained attenuation values and the attenuation calibration value are all greater than the preset threshold (for example, 5 dB) over six occurrences, it may be determined that the antenna is blocked.

A reason why the antenna is blocked may include that the antenna is blocked by a case (whether the case is a protective case or an aesthetic case), or that the antenna is blocked due to a holding position by the user of the communication device. The communication chip may further determine, based on duration in which the difference between the attenuation value and the attenuation calibration value is greater than the preset threshold, a reason as to why the antenna is blocked. For example, within specific duration (for example, 8 hours), when a difference between an attenuation value obtained each time and the attenuation calibration value is greater than the preset threshold (for example, 5 dB), it may be determined that the antenna may be blocked by a protective case. For another example, when a difference between the attenuation value obtained before preset duration (for example, second preset duration) and the attenuation calibration value is less than a preset threshold (for example, a second preset threshold), the communication device determines whether differences between a plurality of attenuation values consecutively obtained within the second preset duration and the attenuation calibration value are all greater than the second preset threshold. If the differences between the plurality of attenuation values consecutively obtained within the second preset duration and the attenuation calibration value are all greater than the second preset threshold, it is determined that the antenna is blocked. For example, when differences between attenuation values obtained in the last few times (for example, attenuation values obtained several times in the last 5 minutes) and the attenuation calibration value are all greater than a preset threshold (for example, 20 dB), and a difference between a previously obtained attenuation value and the attenuation calibration value is less than the preset threshold, it may be determined, with reference to a status indication of the communication device (for example, a landscape display indication of a mobile phone), that the antenna is blocked due to an abnormal holding posture of a user (e.g., the user's hand(s) is(are) placed over the antenna(s)).

It should be noted that, in the foregoing examples, when the difference between the attenuation value and the attenuation calibration value is equal to the preset threshold, it may be determined that the antenna is blocked, or it may be determined that the antenna is not blocked. This is not limited herein. The attenuation calibration value may be an attenuation value of a signal obtained when the antenna is not blocked (for example, when the communication device is bare). For example, an attenuation value that is of a measurement signal and that is determined and obtained through air interface loopback measurement when the communication device is bare.

S403. The communication chip indicates a processor to output, to the user, alarm information prompting that the antenna is blocked.

In some possible implementations, the alarm information may include a reason as to why the antenna is blocked and that is determined by the communication chip. For determining the reason why the antenna is blocked, refer to the description in S402.

S404: The processor controls the communication device to output the alarm information.

For example, the alarm information output by the communication device may be an icon indicating that the antenna is blocked, and/or a pop-up message indicating that the antenna is blocked. For example, when the processor receives indication information, the processor instructs the communication device to display the pop-up message. For example, the pop-up message may be “The antenna of the mobile phone is blocked”.

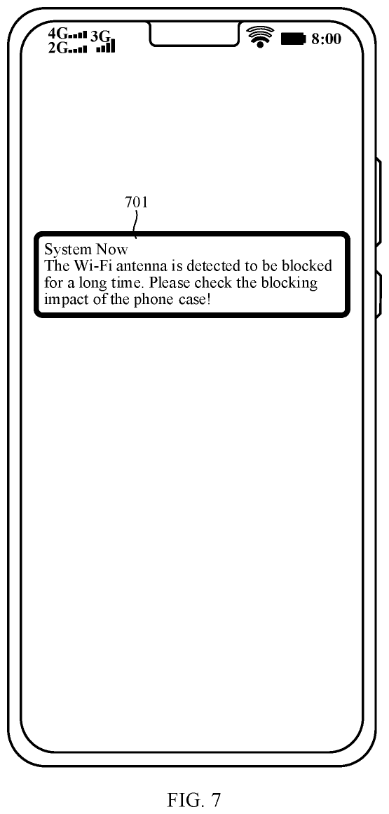

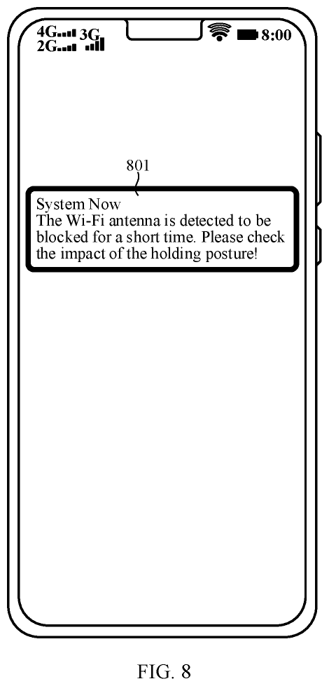

In some possible implementations, the processor may further determine, based on a specific communication chip from which a received indication comes, that a specific antenna is blocked. Then, the alarm information is output based on a reason that is indicated by the communication chip and why the antenna is blocked, and the determined blocked antenna, to prompt a user why a specific antenna is blocked. For example, when the communication chip indicates that the antenna is blocked by the protective case, and the indication is sent by the Wi-Fi module 502 of the communication chip 500 shown in FIG. 5, the processor may determine that a Wi-Fi antenna is blocked by the protective case. The processor may control the communication device to display a pop-up message. As shown in FIG. 7, a pop-up window message 701 may be “The Wi-Fi antenna has been detected to be blocked for a long time. Please check if the phone case is blocking the Wi-Fi antenna!”. For another example, when the communication chip indicates that the antenna is blocked due to an impact of an abnormal holding posture, and the indication is sent by the Wi-Fi module 502 of the communication chip 500 shown in FIG. 5, the processor may determine that a Wi-Fi antenna is blocked due to the impact of the holding posture. The processor may control the communication device to display a pop-up message. As shown in FIG. 8, a pop-up window message 801 may be “The Wi-Fi antenna has been detected to be blocked for a short time. Please check if your hands are blocking the antenna!”.

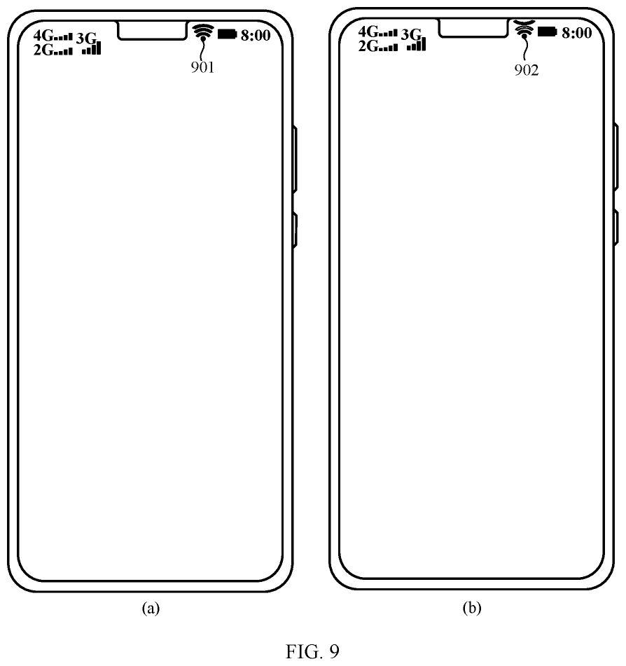

For another example, when the communication chip indicates that the antenna is blocked by the case, and the indication is sent by the Wi-Fi module 502 of the communication chip 500 shown in FIG. 5, the processor may determine that a Wi-Fi antenna is blocked by the case. The processor may control the communication device to display an icon indicating that the Wi-Fi antenna is blocked. For example, before the processor of the mobile phone receives the indication of the communication chip, as shown in (a) in FIG. 9, a first icon 901 indicating a Wi-Fi signal is displayed in a status bar of the mobile phone. After the processor of the mobile phone receives the indication of the communication chip, as shown in (b) in FIG. 9, a second icon 902 is displayed in the status bar of the mobile phone. The second icon 902 indicates that the Wi-Fi antenna is blocked.

According to the foregoing method, the communication chip may determine, based on the attenuation value of the signal when the signal is received, whether the communication device is blocked, and indicate the processor of the communication device to control the communication device to output the alarm information, to prompt the user that the antenna is blocked. In this way, the user can find, based on the alarm information, that the antenna of the communication device is blocked, and then remove an obstacle (such as a case or the user's hands) in a timely manner, to improve the user's experience.

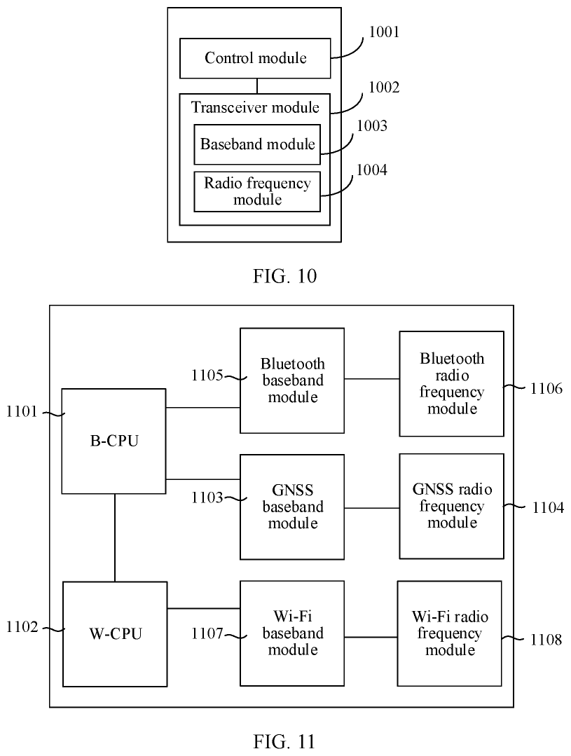

Corresponding to the method in the foregoing embodiments, an embodiment of this application further provides a communication chip. The communication chip may be applied to a communication device, and is configured to implement functions of the communication chip in the method in the foregoing embodiments. The functions of the communication chip may be implemented by using hardware. The communication chip includes one or more modules corresponding to the functions. For example, FIG. 10 is a schematic diagram of a structure of a communication chip. As shown in FIG. 10, the communication chip includes a control module 1001, a transceiver module 1002, and the like. The transceiver module 1002 may further include a baseband module 1003, a radio frequency module 1004, and the like.

The control module 1001 may be configured to obtain an attenuation value of an air interface loopback signal through an antenna. The control module 1001 may be further configured to determine, based on the attenuation value, whether the antenna is blocked. When determining that the antenna is blocked, the control module 1001 may be further configured to indicate a processor to output, to a user, alarm information prompting that the antenna is blocked.

In a possible implementation, the antenna may include a first antenna and a second antenna. The transceiver module 1002 may be configured to transmit, based on control of the control module, a measurement signal through the first antenna, receive the measurement signal looped back to the second antenna, and measure a strength value of the looped back measurement signal. The control module 1001 may be configured to determine the attenuation value based on a strength value of the measurement signal and the strength value of the looped back measurement signal.

In another possible implementation, the transceiver module 1002 may implement functions of the transceiver module 1002 by using the baseband module 1003 and the radio frequency module 1004. For example, the baseband module 1003 may be configured to generate a measurement signal based on control of the control module 1001. The radio frequency module 1004 may be configured to transmit the measurement signal through the first antenna, and receive the measurement signal looped back to the second antenna. The baseband module 1003 may be further configured to measure a strength value of the looped back measurement signal.

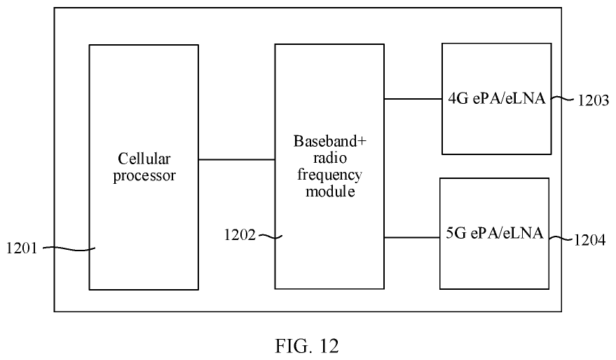

For example, the communication chip 500 shown in FIG. 5 is used as an example. As shown in FIG. 11, the communication chip may include a B-central processing unit (CPU) 1101 (that is, a first control module) and a W-CPU 1102 (that is, a second control module) that are connected to each other, a GNSS baseband module 1103 and a GNSS radio frequency module 1104 that are connected to each other, a Bluetooth baseband module 1105 and a Bluetooth radio frequency module 1106 that are connected to each other, and a Wi-Fi baseband module 1107 and a Wi-Fi radio frequency module 1108 that are connected to each other. The Bluetooth baseband module 1105 and the GNSS baseband module 1103 are separately connected to the B-CPU 1101, and the Wi-Fi baseband module 1107 is connected to the W-CPU 1102. The B-CPU 1101, the Bluetooth baseband module 1105, and the Bluetooth radio frequency module 1106 may form the Bluetooth module 501 of the communication chip 500 shown in FIG. 5. The B-CPU 1101, the GNSS baseband module 1103, and the GNSS radio frequency module 1104 may form the GNSS module 503 of the communication chip 500 shown in FIG. 5. The W-CPU 1102, the Wi-Fi baseband module 1107, and the Wi-Fi radio frequency module 1108 may form the Wi-Fi module 502 of the communication chip 500 shown in FIG. 5. The foregoing functions of the communication chip 500 shown in FIG. 5 may be implemented by using the communication chip. For example, when a Wi-Fi service is idle, the B-CPU 1101 may control the Bluetooth baseband module 1105 to generate a monophonic signal or a modulation signal of specific strength, for example, a first strength value, as a measurement signal. The Bluetooth radio frequency module 1106 may amplify the measurement signal to a radio frequency band, and transmit the measurement signal through the Ant 0 shown in FIG. 5. Then, the Wi-Fi radio frequency module 1108 may receive the measurement signal through the Ant 2 shown in FIG. 5, and convert the measurement signal to a baseband frequency band. The Wi-Fi baseband module 1107 may measure a strength value of the measurement signal of the baseband frequency band, for example, obtain a second strength value. Then, the W-CPU 1102 may obtain the first strength value from the B-CPU 1101, and obtain the second strength value from the Wi-Fi baseband module 1107. A difference between the first strength value and a second strength value that is obtained by converting post-gain strength values generated by the Bluetooth radio frequency module 1106 and the Wi-Fi radio frequency module 1108, is determined as the attenuation value of the measurement signal, and air interface loopback measurement is completed.

For another example, the communication chip 600 shown in FIG. 6 is used as an example. As shown in FIG. 12, the communication chip may include a cellular processor 1201 (that is, a control module), a baseband module, a radio frequency module (which may be integrated into one module, that is, a baseband+radio frequency module 1202), a 4G power/low noise amplifier (4G external PA/external LNA, 4G ePA/eLNA) 1203, and a 5G power/low noise amplifier (5G external PA/external LNA, 5G ePA/eLNA) 1204. The cellular processor 1201, the baseband+radio frequency module 1202, and the 4G ePA/eLNA 1203 may form the 4G LTE module 601 of the communication chip 600 shown in FIG. 6. The cellular processor 1201, the baseband+radio frequency module 1202, and the 5G ePA/eLNA 1204 may form the 5G NR module 602 of the communication chip 600 shown in FIG. 6. The foregoing functions of the communication chip 600 shown in FIG. 6 may be implemented by using the communication chip. For example, the cellular processor 1201 may control the baseband module in the baseband+radio frequency module 1202 to generate a monophonic signal or a modulation signal of specific strength, for example, a first strength value, as a measurement signal, and the radio frequency module amplifies the measurement signal to a radio frequency band. Then, the 4G ePA/eLNA 1203 further amplifies the measurement signal and separately transmits the measurement signal through the Ant 0 and the Ant 1 shown in FIG. 6. Then, the 4G ePA/eLNA 1203 may receive, through the Ant 2 shown in FIG. 6, the measurement signal separately transmitted through the Ant 0 and the Ant 1, to form two air interface loopbacks. The radio frequency module in the baseband+radio frequency module 1202 may convert the separately received measurement signals to a baseband frequency band, and then the baseband module separately measures strength values of the two received measurement signals, for example, obtains a second strength value and a third strength value. The cellular processor 1201 may obtain the second strength value and the third strength value, obtain a first attenuation value based on a difference between the first strength value and the second strength value, and obtain a second attenuation value based on a difference between the first strength value and the third strength value. Finally, a final attenuation value is determined based on an average value of the first attenuation value and the second attenuation value, and air interface loopback measurement is completed.

In another possible implementation, the control module 1001 may be configured to periodically obtain a plurality of attenuation values based on a preset periodicity, and determine, based on the plurality of obtained attenuation values, whether the antenna is blocked.

In another possible implementation, the control module 1001 may be configured to determine whether a difference between the attenuation value within first preset duration and an attenuation calibration value is greater than a first preset threshold. When the difference between the attenuation value within the first preset duration and the attenuation calibration value is greater than the first preset threshold, the control module 1001 may determine that the antenna is blocked. When the difference between the attenuation value within the first preset duration and the attenuation calibration value is not greater than the first preset threshold, the control module 1001 may determine that the antenna is not blocked.

In another possible implementation, the control module 1001 may be configured to, when a difference between the attenuation value obtained before second preset duration and an attenuation calibration value is less than a second preset threshold, determine whether differences between a plurality of attenuation values consecutively obtained within the second preset duration and the attenuation calibration value are all greater than the second preset threshold. When the differences between the plurality of attenuation values consecutively obtained within the second preset duration and the attenuation calibration value are all greater than the second preset threshold, the control module 1001 may determine that the antenna is blocked. When the differences between the plurality of attenuation values consecutively obtained within the second preset duration and the attenuation calibration value are not all greater than the second preset threshold, the control module 1001 may determine that the antenna is not blocked.

In another possible implementation, the control module 1001 may be configured to determine, based on status indication information, that the antenna is blocked due to an abnormal holding posture by the user, where the status indication information indicates that a communication device is in a landscape mode.

It should be understood that a division into the units (e.g., circuits) or modules (referred to as units) in the communication chip is merely logical function division. In actual implementation, all or some of the units or modules may be integrated into one physical entity, or may be physically separated.

For example, each unit may be an independently disposed processing element, or may be integrated into a chip for implementation.

In an example, the unit in the communication chip may be one or more integrated circuits configured to implement the foregoing methods, for example, one or more ASICs, one or more DSPs, one or more FPGAs, or a combination of at least two of the integrated circuit forms.

For another example, the units may be integrated and implemented in a form of a system-on-a-chip (SOC).

An embodiment of this application may further provide a communication device. The communication device may include a processor, and a memory configured to store executable instructions of the processor. When the processor is configured to execute the instructions, the communication device is enabled to implement the antenna blocking alarm method described in the foregoing embodiments. The memory may be located inside the communication device, or may be located outside the communication device.

An embodiment of this application further provides a computer program product, including computer instructions run by a communication device, such as the foregoing communication device.

An embodiment of this application may further provide a computer-readable storage medium, and the computer-readable storage medium stores computer program instructions. When the computer program instructions are executed by a communication device, the communication device is enabled to implement the antenna blocking alarm method described in the foregoing method embodiments.

The foregoing descriptions are merely implementations of this application, but are not intended to limit the protection scope of this application. Any variation or replacement within the technical scope disclosed in this application shall fall within the protection scope of this application. Therefore, the protection scope of this application shall be subject to the protection scope of the claims.

1. A blocked antenna alarm method, comprising:
obtaining, by a communication chip, an attenuation value of an air interface loopback signal through an antenna of a communication device;
determining, by the communication chip based on the attenuation value, whether the antenna is blocked; and
when determining that the antenna is blocked, indicating, by the communication chip, a processor of the communication device to output, to a user, alarm information indicating that the antenna is blocked.

2. The method according to claim 1, wherein the antenna comprises a first antenna and a second antenna; and
the obtaining, by the communication chip, the attenuation value of the air interface loopback signal through the antenna comprises:
transmitting, by the communication chip, a measurement signal through the first antenna, and receiving the measurement signal looped back to the second antenna; and
determining, by the communication chip, the attenuation value based on a strength value of the measurement signal and a strength value of the looped back measurement signal.

3. The method according to claim 2, wherein the communication chip comprises a Bluetooth module and a wireless fidelity (Wi-Fi) network module, and the transmitting, by the communication chip, the measurement signal through the first antenna, and receiving the measurement signal looped back to the second antenna comprises:
transmitting, by the Bluetooth module, the measurement signal through the first antenna;
receiving, by the Wi-Fi network module, the measurement signal looped back to the second antenna; and
determining, by the Wi-Fi network module, the attenuation value based on the strength value of the measurement signal and the strength value of the looped back measurement signal.

4. The method according to claim 1, wherein
the obtaining, by the communication chip, the attenuation value of the air interface loopback signal through the antenna comprises:
periodically obtaining, by the communication chip, a plurality of attenuation values based on a preset periodicity; and
the determining, by the communication chip based on the attenuation value, whether the antenna is blocked comprises:
determining, by the communication chip based on the plurality of obtained attenuation values, whether the antenna is blocked.

5. The method according to claim 1, wherein the determining, by the communication chip based on the attenuation value, whether the antenna is blocked comprises:
determining, by the communication chip, whether a difference between the attenuation value within a preset duration and an attenuation calibration value is greater than a preset threshold;
when the difference between the attenuation value within the preset duration and the attenuation calibration value is greater than the preset threshold, determining, by the communication chip, that the antenna is blocked; and
when the difference between the attenuation value within the preset duration and the attenuation calibration value is not greater than the preset threshold, determining, by the communication chip, that the antenna is not blocked.

6. The method according to claim 4, wherein the determining, by the communication chip based on the attenuation value, whether the antenna is blocked comprises:
when a difference between the attenuation value obtained before a preset duration and an attenuation calibration value is less than a preset threshold, determining, by the communication chip, whether differences between a plurality of attenuation values consecutively obtained within the second preset duration and the attenuation calibration value are all greater than the preset threshold;
when the differences between the plurality of attenuation values consecutively obtained within the preset duration and the attenuation calibration value are all greater than the preset threshold, determining, by the communication chip, that the antenna is blocked; and
when the differences between the plurality of attenuation values consecutively obtained within the preset duration and the attenuation calibration value are not all greater than the preset threshold, determining, by the communication chip, that the antenna is not blocked.

7. The method according to claim 6, wherein the determining, by the communication chip, that the antenna is blocked comprises:
determining, by the communication chip based on status indication information, that the antenna is blocked due to a holding position by the user of the communication device, wherein the status indication information indicates that the communication device is in a landscape mode.

8. A blocked antenna alarm method, comprising:
obtaining, by a communication device, an attenuation value of an air interface loopback signal through an antenna of the communication device;
determining, by the communication device based on the attenuation value, whether the antenna is blocked; and
when determining that the antenna is blocked, outputting, by the communication device to a user, alarm information indicating that the antenna is blocked.

9. The method according to claim 8, wherein the antenna comprises a first antenna and a second antenna; and
the obtaining, by a communication device, an attenuation value of an air interface loopback signal through an antenna comprises:
transmitting, by the communication device, a measurement signal through the first antenna, and receiving the measurement signal looped back to the second antenna; and
determining, by the communication device, the attenuation value based on a strength value of the measurement signal and a strength value of the looped back measurement signal.

10. The method according to claim 8, wherein
the obtaining, by the communication device, the attenuation value of the air interface loopback signal through the antenna comprises:
periodically obtaining, by the communication device, a plurality of attenuation values based on a preset periodicity; and
the determining, by the communication device based on the attenuation value, whether the antenna is blocked comprises:
determining, by the communication device based on the plurality of obtained attenuation values, whether the antenna is blocked.

11. The method according to claim 8, wherein the determining, by the communication device based on the attenuation value, whether the antenna is blocked comprises:
determining, by the communication device, whether a difference between the attenuation value within a preset duration and an attenuation calibration value is greater than a first preset threshold;
when the difference between the attenuation value within the preset duration and the attenuation calibration value is greater than the preset threshold, determining, by the communication device, that the antenna is blocked; and
when the difference between the attenuation value within the preset duration and the attenuation calibration value is not greater than the preset threshold, determining, by the communication device, that the antenna is not blocked.

12. The method according to claim 10, wherein the determining, by the communication device based on the attenuation value, whether the antenna is blocked comprises:
when a difference between the attenuation value obtained before a preset duration and an attenuation calibration value is less than a preset threshold, determining, by the communication device, whether differences between a plurality of attenuation values consecutively obtained within the preset duration and the attenuation calibration value are all greater than the preset threshold;
when the differences between the plurality of attenuation values consecutively obtained within the preset duration and the attenuation calibration value are all greater than the preset threshold, determining, by the communication device, that the antenna is blocked; and
when the differences between the plurality of attenuation values consecutively obtained within the preset duration and the attenuation calibration value are not all greater than the preset threshold, determining, by the communication device, that the antenna is not blocked.

13. The method according to claim 12, wherein the determining, by the communication device, that the antenna is blocked comprises:
determining, by the communication device based on status indication information, that the antenna is blocked due to a holding position by the user of the communication device, wherein the status indication information indicates that the communication device is in a landscape mode.

14. The method according to claim 8, wherein the outputting, by the communication device to the user, the alarm information indicating that the antenna is blocked comprises:
displaying, by the communication device, a user interface, wherein the user interface comprises: at least one of an icon indicating that the antenna is blocked, or a pop-up message indicating that the antenna is blocked.

15. The method according to claim 8, further comprising:
displaying, by the communication device, a first icon, wherein the first icon indicates a strength of the signal received by the communication device, wherein the outputting, by the communication device to the user, the alarm information indicating that the antenna is blocked comprises:
updating and displaying, by the communication device, the first icon as a second icon, wherein the second icon indicates that the antenna is blocked.

16. A communication chip, comprising a control module, configured to:
obtain an attenuation value of an air interface loopback signal through an antenna of a communication device;
determine, based on the attenuation value, whether the antenna is blocked; and
when determining that the antenna is blocked, indicate a processor of the communication device to output, to a user, alarm information indicating that the antenna is blocked.

17. The communication chip according to claim 16, wherein the antenna comprises a first antenna and a second antenna, and the communication chip further comprises a transceiver module;
the transceiver module is configured to transmit, based on control of the control module, a measurement signal through the first antenna, receive the measurement signal looped back to the second antenna, and measure a strength value of the looped back measurement signal; and
the control module is configured to determine the attenuation value based on a strength value of the measurement signal and the strength value of the looped back measurement signal.

18. The communication chip according to claim 17, wherein the transceiver module comprises a baseband module and a radio frequency module;
the baseband module is configured to generate the measurement signal based on the control of the control module;
the radio frequency module is configured to transmit the measurement signal through the first antenna, and receive the measurement signal looped back to the second antenna; and
the baseband module is further configured to measure the strength value of the looped back measurement signal.

19. The communication chip according to claim 18, wherein:
the control module comprises a first control module and a second control module, the baseband module comprises a Bluetooth baseband module and a wireless fidelity (Wi-Fi) baseband module, and the radio frequency module comprises a Bluetooth radio frequency module and a Wi-Fi radio frequency module;
the Bluetooth baseband module is configured to generate the measurement signal based on control of the first control module;
the Bluetooth radio frequency module is configured to transmit the measurement signal through the first antenna;
the Wi-Fi radio frequency module is configured to receive the measurement signal looped back to the second antenna;
the Wi-Fi baseband module is configured to measure the strength value of the looped back measurement signal; and
the second control module is configured to determine the attenuation value based on the strength value of the measurement signal and the strength value of the looped back measurement signal.

20. The communication chip according to claim 16, wherein the control module is configured to periodically obtain a plurality of attenuation values based on a preset periodicity, and determine, based on the plurality of obtained attenuation values, whether the antenna is blocked.
